(19) United States
(12) Patent Application Publication
(10) Pub. No.: US 2014/0026209 A1
(43) Pub. Date: Jan. 23, 2014

(54) DISTRIBUTION DEVICE, IMAGE FORMING DEVICE, SYSTEM, CONTROL METHOD AND STORAGE MEDIUM

(71) Applicant: Canon Kabushiki Kaisha, Tokyo (JP)

(72) Inventor: Hideo Asahara, Yokohama-shi (JP)

(21) Appl. No.: 13/938,378

(22) Filed: Jul. 10, 2013

(30) Foreign Application Priority Data
Jul. 18, 2012 (JP) 2012-159900

(51) Int. Cl. G06F 21/31

(52) U.S. Cl. CPC G06F 21/31
USPC 726/16

(57) ABSTRACT

A management server designates an image forming device to which import data including a plurality of setting values is distributed, and distributes the import data to the designated image forming device. When the distributed import data is reflected in the image forming device, the authentication information of the user who instructs the distribution of the import data is input, and a login by authentication processing using the input authentication information fails, the image forming device rolls back the settings for user authentication processing to the settings before the import data is reflected.

### BACKGROUND OF THE INVENTION

1. Field of the Invention

This invention relates to a technology of importing altogether the settings for user authentication to an image forming device having a user authentication function.

2. Description of the Related Art

There has been proposed an image forming device having a function of performing user authentication using the settings for user authentication processing. In addition, there has also been proposed an image forming device that preserves a function of exporting and importing altogether authentication data including the settings for user authentication processing. For example, a distribution device, such as a PC, distributes authentication data to an image forming device in accordance with an instruction of an administrator user of the image forming device, and the image forming device imports this authentication data altogether.

Generally, an administrator user who is the system operator of an image forming device has an authority to change the settings for authentication processing for a general user. Japanese Patent Application Laid-Open No. 2011-70289 discloses a mechanism of automatically returning a temporarily permitted authority of the system operator to a normal authority when a predetermined condition is not met.

There is the case where no user succeeds in user authentication when an image forming device imports incorrect authentication data distributed from a distribution device. Particularly, an administrator user cannot log into an image forming device when the settings for authentication processing about the administrator user is overwritten as the result of import of authentication data. Consequently, the settings cannot be returned back (rolled back) after the import of authentication data.

Here, for example, even with the technology of Japanese Patent Application Laid-Open No. 2011-70289, an administrator user who has an authority for changing the settings cannot return it to the correct setting in the case where he cannot log into an image forming device.

### SUMMARY OF THE INVENTION

The present invention provides a mechanism of rolling back settings for user authentication processing when import data including the settings is distributed to an image device, and when the user who instructs a distribution of the import data fails login.

The distribution device of an embodiment of this invention is a distribution device that distributes import data including a plurality of setting values to an image forming device. The distribution device includes a designation unit configured to designate an image forming device to which the import data is distributed; and a distribution unit configured to distribute the import data to the designated image forming device. When the distributed import data is reflected in the image forming device, the authentication information of a user who instructs the distribution of the import data is input, a login by authentication processing using the input authentication information fails, the image forming device rolls the settings back to the settings before the import data is reflected.

Further features of the present invention will become apparent from the following description of exemplary embodiments with reference to the attached drawings.

### BRIEF DESCRIPTION OF THE DRAWINGS

FIG. 1 shows the system configuration of a first embodiment.

FIG. 2 shows an example of a user database.

FIG. 3 shows an example of an import data file.

FIG. 4 is an example of a hardware configuration diagram of an image forming device.

FIG. 5 is an example of a functional block diagram of an image forming device.

FIG. 6 shows an example of an import execution instruction screen.

FIG. 7 shows an example of an import result confirmation screen.

FIG. 8 is a flow chart explaining operation processing by the image forming device in the first embodiment.

FIG. 9 is an example of a hardware configuration diagram of the image forming device of a second embodiment.

FIG. 10 is a functional block diagram of the system of the second embodiment.

FIG. 11 shows an example of a post-import authentication screen.

FIG. 12 is a flow chart explaining operation processing by the image forming device in the second embodiment.

FIG. 13 is a flow chart explaining the operation processing by the image forming device in the second embodiment.

### DESCRIPTION OF THE EMBODIMENTS

### First Embodiment

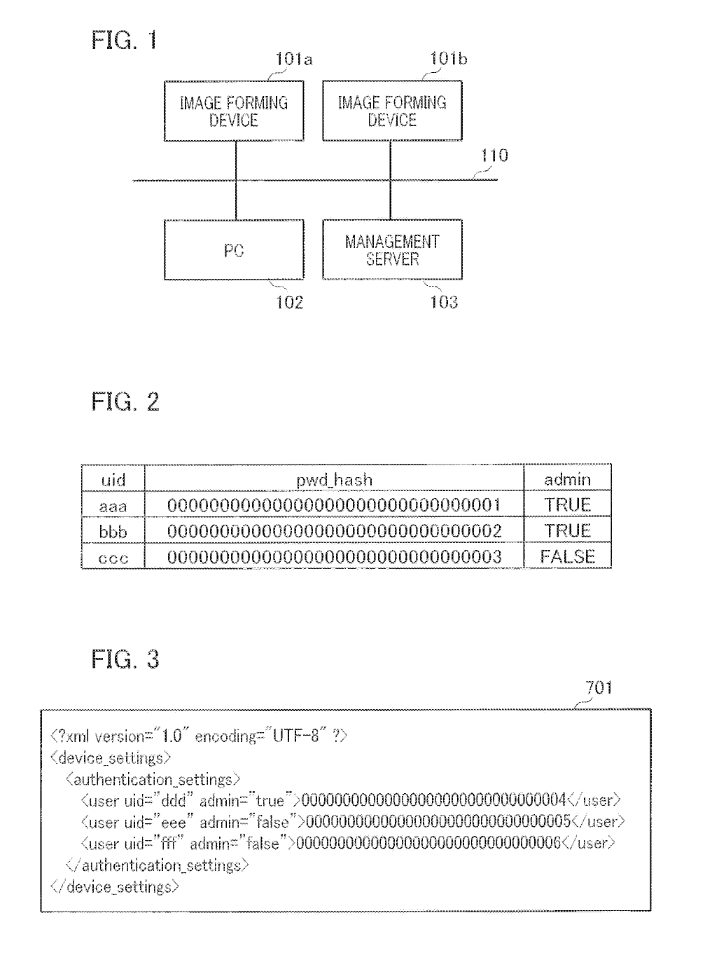

FIG. 1 is a diagram showing the system configuration of a first embodiment. First, terms used herein is defined with reference to the device shown in FIG. 1. A “user” is the operator of an image forming device 101 and a management server 103. An “administrator user” is the user who administrates the image forming device 101 and the management server 103. The administrator user can utilise all functions provided by the image forming device 101 and the management server 103.

A “general user” is the user who is not the administrator user, and can utilize some of the functions provided by the image forming device 101 and the management server 103. Assume that the functions that can be implemented by only the administrator user include a function of changing the settings for user authentication processing.

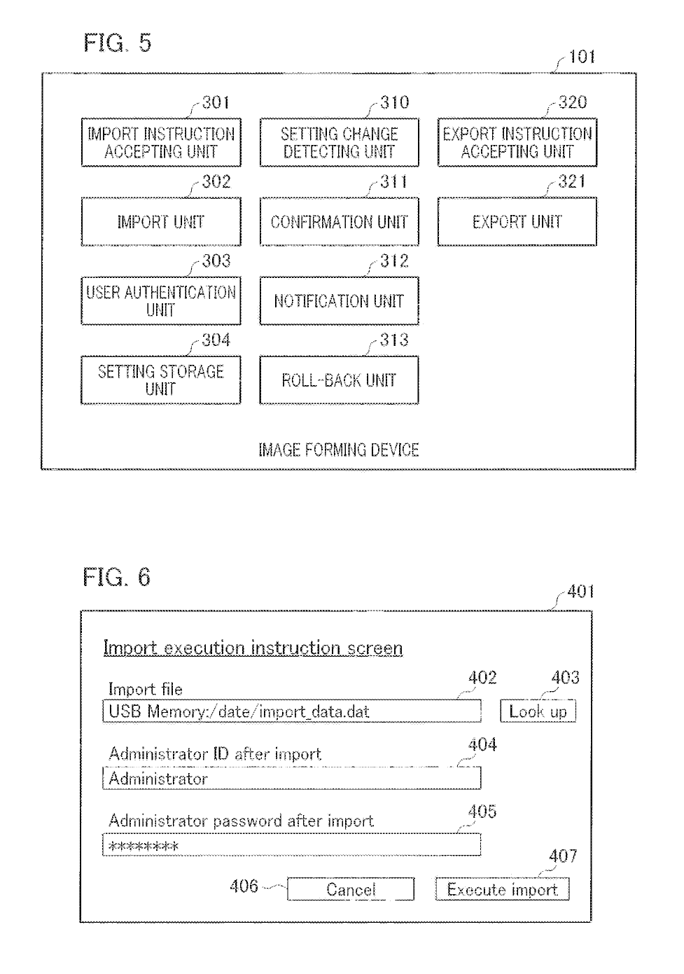

The settings for user authentication processing are the settings for user authentication by a user authentication unit 303 (FIG. 5) of the image forming device 101. To authenticate a user is to determine what kind of user is who intends to utilize the image forming device 101. To be user authenticated refers to a state in which one has been determined as an administrator user, a general user, or a correct user. Examples of the settings for the user authentication processing include a user database, which will be described below with reference to FIG. 2. The user database is a database that manages information about users who can utilize the functions of the image forming device 101.

FIG. 2 is a diagram showing an example of the user database, “uid” is an identifier that uniquely identifies a user. “pwd_hash” is the data that a password character string of a user is hashed. “admin” is the data that indicates whether or not a user is an administrator user. “TRUE” set in “admin” indicates that a user is an administrator user. “FALSE” set in “admin” indicates that a user is a general user. The user authentication unit 303 which will be described below performs user authentication by using information set in the user database.

Import data is data utilized upon back-up of the settings of the image forming device 101, and synchronization with the settings exported from another image forming device 101. In the present embodiment, the import data includes each operational setting information of the image forming device 101, address book information, and the settings for user authentication processing. A user can optionally determine what bind, of information to include in the import data. The import data filed in the import data is an import data file.

FIG. 3 is a diagram showing an example of the import data file. In this example, an import data file 701 is expressed in an XML file format. The attributes “uid” and “admin” are present in a “user” tag included in the import data file 701. “uid” corresponds to “uid” in the user database shown in FIG. 2. Additionally, “admin” corresponds to “admin” in the user database shown in FIG. 2. A character string is set as a value of the sag included in the import data file 701. This character string corresponds to the information of “pwd_hash” in the user database shown in FIG. 2. In this way, the data items in the user database shown in FIG. 2 and information set in the tag of the import data file 701 shown in FIG. 3 correspond to each other. The import data file 701 shown in FIG. 3 indicates merely a minimal configuration, and thus the import data file 701 may have information other than the information shown in FIG. 3.

The import data can be acquired by an export unit 321 (FIG. 5) provided in the image forming device 101 provides. The export unit 321 will be described below. A PC 102 may be configured to generate the import data, and the management server 103 may be configured to generate the import data.

Upon import of the import data, the settings for the user authentication processing included in the import data are reflected in the user database (FIG. 2) provided in the image forming device 101. “Reflection” denotes changing the parameters on software, executing an operation, and the like. Additionally, the settings for user authentication processing may be written down as export data of the user database provided in the image forming device 101.

Returning to FIG. 1, the information processing system of the present embodiment includes image forming devices 101a, 101b, a PC 102, and an management server 103. Hereinafter, the image forming devices 101a and 101b will be also merely described as an image forming device 101. The image forming device 101a, 101b, the PC 102, and the management server 103 are connected via a network (a LAN in the example shown in FIG. 1) 110. “LAN” is an abbreviation of Local Area Network.

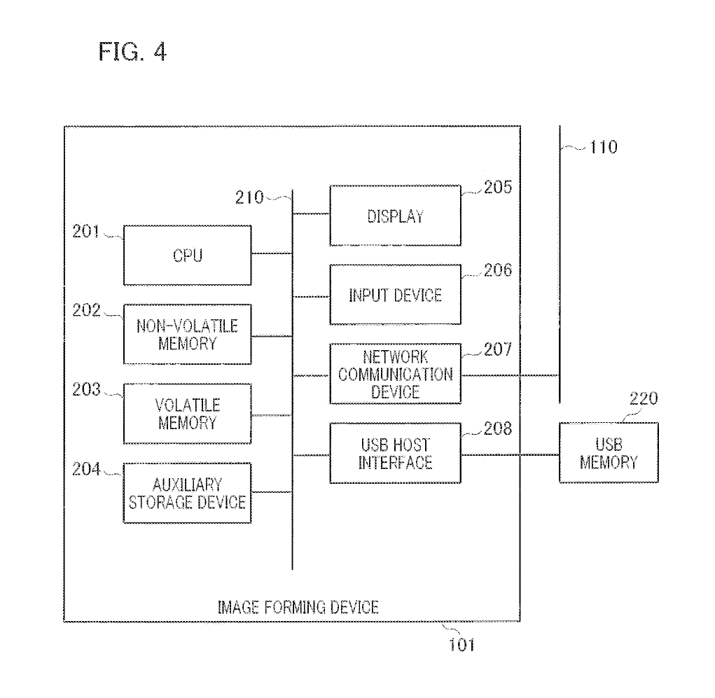

The image forming device 101 is a device having a function of forming an image, as represented by a multi-function machine. In the present embodiment, although the image forming device 101a and the image forming device 101b have similar functions, there may be difference in minute points such as the model. The image forming device 101 is communicable with other information appliances connected to the LAN 110 via the LAN 110. The details of functions provided in the image forming device 101 will be described below with reference to FIG. 4, FIG. 5.

The PC 102 is a personal computer, and includes a network communicable function and a Web browser. The PC 102 is communicable with other information appliances connected to the LAN 110. The management server 103 is a server computer, and includes a network communicable function. The management server 103 is communicable with other information appliances connected to the LAN 110. The management server 103 functions as a distribution device that distributes import data including a plurality of setting values to the image forming device 101. The PC 102 may function as the distribution device. The control method of the distribution device is achieved by the function of each processing unit provided in the management server 103 and the PC 102. The LAN 110 is a network that allows digital communication. The image forming device 101, the PC 102, and the management server 103 are connected to the LAN 110 to thereby communicate with each other.

FIG. 4 is an example of a hardware configuration of an image forming device. A CPU (Central Processing Unit) 201 performs the control of various processes executed by an image forming device via execution of computer program. A non-volatile memory 202 is composed of ROMs. “ROM” is an abbreviation of “Read Only Memory”. Program and data necessary for the initial stage in activation processing of an appliance is stored in the non-volatile memory 202. A volatile memory 203 is composed of RAM. “RAM” is an abbreviation of Random Access Memory. The volatile memory 203 is utilised as a temporary storage location for programs and data.

An auxiliary storage devise 204 is composed of mass storage devices such as a hard disk and a RAM drive. The auxiliary storage device 204 performs storage of large volume data, preservation of executable codes of program, and preservation of the setting values of the image forming device 101. The auxiliary storage device 204 stores data which is needs to be preserved for a long time, as compared to the volatile memory 203. Since the auxiliary storage device 204 is a non-volatile storage device, it can continue to store data even when the power source of the image forming device 101 is turned off.

A display 205 is a display device that communicates information to a user. An input device 206 is a device that accepts a selection instruction of a user to deliver the accepted selection instruction to a program via an infernal bus 210. A network communication device 207 is a device that communicates with other information processing devices connected via the LAN 110. A USB host interface 208 is an interface that makes a connected USB device available. “USB” is an abbreviation of “Universal Serial Bus”. The USB host interface 208, for example, connects a USB memory, and is capable of reading and writing of data.

The internal bus 210 is a communication bus that connects the CPU 201 to the USB host interface 208 so that they can communicate with each other in the image forming device 101. A USB memory 220 is a non-volatile data storage. Specifically, the USB memory 220 is an appliance capable of reading and writing of data by being connected to an information appliance comprising the USB host interface 208.

FIG. 5 is an example of the functional block diagram of an image forming device. The image forming device 101 includes an import instruction accepting unit 301, an import unit 302, a user authentication unit 303, a setting storage unit 304, a setting change detecting unit 310, a confirmation unit 311, and a notification unit 312. Also, the image forming device 101 includes a roll-back unit 313, an export instruction accepting unit 320, and an export unit 321.

The program that achieves the function of each processing unit shown in FIG. 3 is stored in the non-volatile memory 202 or the auxiliary storage device 204 in the image forming device 101, and executed by the CPU 201. Various information used upon execution of the above program is preserved in the volatile memory 203 or the auxiliary storage device 204 in the image forming device 101. Further, the communication with each information appliance on a network is performed using the network communication device 207 in the image forming device 101.

The import instruction accepting unit 301 accepts an instruction of importing the setting values of the image forming device 101 (import instruction) using a variety of interfaces provided in the image forming device 101. As described below, import data having a plurality of setting values is included in the import instruction. Therefore, the import instruction accepting unit 301 functions as a receiving unit that receives import data. In the present embodiment, there are three routes serving as the routes to import setting values. The first route is a route to perform an import instruction from the PC 102 to the image forming device 101 via the LAN 110 using web browser. When an import instruction is performed in this route, the PC 102 includes a designating unit (not shown) that designates an image forming device to be distributed import data included in import instructions, and a distributing unit (not shown) that distributes import data to the designated image forming device.

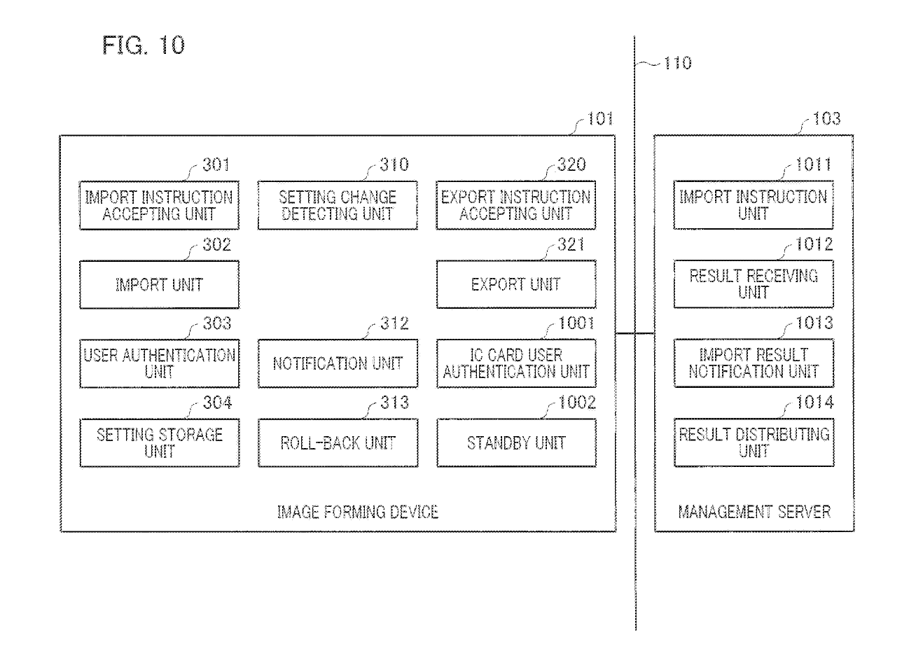

The second route is a route to perform an import instruction from the management server 103 to the image forming device 101 via the LAN 110. When an import instruction is performed in this route, the management server 103 includes a predetermined processing unit that functions as the above-described designating unit and distributing unit (for example, an import instruction unit 1011 of FIG. 10). The third route is a route to perform an import instruction on the image forming device 101 via the USB host interface 208 using the USB memory 220. The import instruction accepting unit 301 accepts an import instruction through the plurality of routes. In the first embodiment, although the third route, i.e., an import instruction using the USB memory 220 is mainly explained, a similar result can be obtained even when an import instruction were to be performed through any route.

An import instruction includes the designation of import data to be reflected on the image forming device 101 that is a target of import processing. Here, the settings for user authentication processing included in import data are, for example, a user ID and password. Additionally, in this example, an import instruction also includes a user ID and password that one plans to use as an administrator user after import processing. Further, an import instruction is temporarily stored in the auxiliary storage device 202 by the import instruction accepting unit 301. In this example an import instruction is performed via an import execution instruction screen displayed on the image forming device 101.

FIG. 6 is a diagram showing an example of an import execution instruction screen. An import execution instruction screen 401 is a screen used for performing an import instruction using the USB memory 220. In this example, the import instruction accepting unit 301 displays the import execution instruction screen.

An import file name 402 in the import execution instruction screen is a field in which a path and file name in the USB memory 220, of an import file desired to import, are displayed. The example shown in FIG. 6 shows that an import file specified with one path and file name “/date/import_DATA.dat” is selected.

A look-up button 403 is a button for displaying a file chooser (illustration omitted), which is a screen for selecting an import file desired to import. A user selects an import file while the files stored in the USB memory 220 is displayed as a list on the file chooser.

An administrator ID 404 after import is a field in which a user-authenticable user ID is input as an administrator user after import processing. Here, an example is shown in which the user ID “Administrator” is input. An administrator password 405 after import is a field in which a password corresponding to a user-authenticable user ID is input as an administrator user after import processing. It is displayed as “********” so as not to be invisible on a UI.

A cancel button 406 is a button for cancelling an import instruction. When a user presses down the cancel button 406, the import instruction accepting unit 301 closes the import execution instruction screen 401 to cause screen transition to another screen such as a main screen (not illustrated).

An import execution button 407 is a button for establishing an import instruction. When the import execution button 107 is pressed down, the import instruction accepting unit 301 accepts the established import instruction. Additionally, the import instruction accepting unit 301 inputs authentication information (user ID and password) of a user who instructed to import.

Returning to FIG. 5, the import unit 302 imports, to the image forming device 101, the import data which the import instruction accepting unit 301 has accepted an import instruction to store. That is, the import unit 302 reflects the import data in its host device. For example, a case is explained in which the import unit 302 imports the import data file 701 shown in FIG. 3 to the image forming device 101 having the user database shown in FIG. 2.

The user database shown in FIG. 2 is stored in the auxiliary storage device 204. In the example shown in FIG. 2, there exist three users whose “uid”s are “aaa”, “bbb”, “ccc”. Here, “aaa”, “bbb” are the administrator users. The settings for user authentication processing in the import data file 701 are reflected in the user database by the import of the import data file 701 shown in FIG. 3. Consequently, the user database is changed to the state in which there exist three users whose “uid”s are “ddd”, “eee”, “fff”. In addition, “ddd” is the administrator user.

The user authentication unit 303 executes user authentication processing of the image forming device 101. There is a plurality of means that performs user authentication processing. For example, in the case of performing an import instruction to the image forming device 101 by way of the LAN 110 using web browser from the PC 102, a user ID and password are input on a user authentication screen (not illustrated) displayed on the web browser. The input user ID and password are transmitted to the image forming device 101 via the LAN 110.

In the case of performing an import instruction from the management server 103 to the image forming device 101 by way of the LAN 110, a user inputs a user ID and password on a user authentication screen (not illustrated) displayed on a display (not illustrated) which the management server 103 comprises. The input user ID and password are transmitted to the image forming device 101 by way of the LAN 110.

In the case of performing an import instruction using the USB memory 220, a user inputs a user ID and password on a user authentication screen (not illustrated) displayed on the display 205 of the image forming device 101. In the first embodiment, although the processing of the user authentication unit 303 in the case of performing an import instruction using the USB memory 220 is further explained in detail, similar processing is also performed in the case of performing an import instruction from the PC 102 or the management server 103.

Assume that a user inputs a user ID and password to the image forming device 101. The input is performed to an authentication screen (not illustrated) displayed on the display 205 using the input device 206. The input user ID corresponds to the “uid” of the user database shown in FIG. 2. The user authentication unit 303 generates a hash value to the input password character string in a predetermined manner.

The user authentication unit 303 determines whether or not the generated hash value corresponds to the value of the “pwd_hash” corresponding to the above input user ID of the user database shown in FIG. 2. When the generated hash value corresponds to the value of the “pwd_hash” of the user database, the user authentication unit 303 determines that the user corresponding to this user ID is a correct user, and permits the login of this user (user authentication is successful). When the generated hash value does not correspond to the value of the “pwd_hash” of the user database, the user authentication unit 303 determines that the user corresponding to this user ID is not a correct user, and does not permit the log-n of this user (user authentication fails).

The setting storage unit 304 stores the settings for user authentication processing, as represented by the user database shown in FIG. 2. This setting is stored in the auxiliary storage device 204. The setting change detecting unit 310 detects that the settings for user authentication processing, which is stored in the setting storage unit 304, are changed. When the settings for user authentication processing are changed due to of import data by the import unit 302, the setting change detecting unit 310 detects that the settings for user authentication processing are changed.

The confirmation unit 311 performs user authentication processing based on the user authentication information input together with the import instruction accepted by the import instruction accepting unit 301, and the user ID and password corresponding to the administrator user in the user database. Then, the confirmation unit 311 determines the success or failure of the login to its own device.

Assume, for example, that the import data file 701 shown in FIG. 3 is imported. In this case, the administrator user is a user having the user ID “ddd”. Under this state, assume that the user ID “Administrator” is designated in the import execution instruction screen 401, as shown in FIG. 6. In this case, the user ID of the administrator user who performs an import execution instruction, and the user ID of the administrator user reflected in the user database of the image forming device 101, are different. Therefore, the confirmation unit 311 determines that the user authentication fails. In addition, when the correct password “ddd” is input on the import execution instruction screen 401, the confirmation unit 311 determines that the user authentication is successful, that is, the login is successful.

The notification unit 312 issues a notification about an execution result (import result) of the import instruction accepted by the import instruction accepting unit 301. The notification method of an import result varies depending on the mode in which the import instruction accepting unit 301 accepts the import instruction. In the case of performing an import instruction from the PC 102 to the image forming device 101 Via the LAN 110 using a web browser, the notification unit 312 notifies the PC 102 about an import result as a response to the web browser.

In the case of performing an import instruction from the management server 103 in the image forming device 101 via the LAN 110, the notification unit 312 notifies the management server 103 of an import result via the LAN 110. In the case of performing an import instruction to the image forming device 101 via the USB host interface 208 using the USB memory 220, the notification unit 312 displays an import result on the display 205. In The first embodiment, the notification 312 displays an import result confirmation screen including an import result on the display 205.

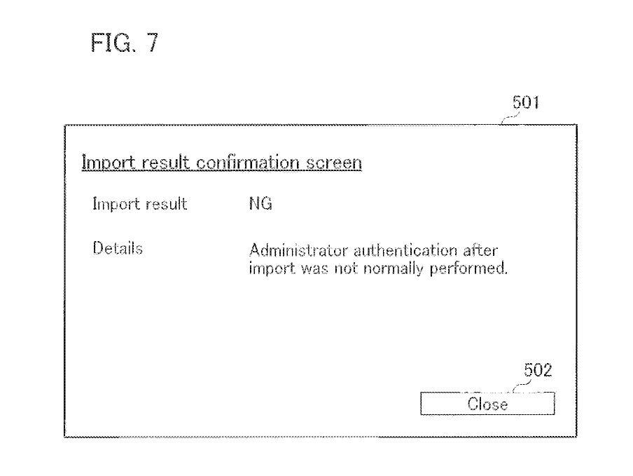

FIG. 7 is a diagram showing an example of an import result confirmation screen. An import result confirmation screen 301 is a screen for notifying a user about an import result. Here, the screen shows that the import result is “NG”, and that the user authentication by the confirmation unit 311 fails as the factor. When the user authentication by the confirmation unit 311 was to be successful, the import result would be displayed as “OK”. Additionally, a message providing notification that import processing has correctly ended is displayed as the factor. When a user presses down a close button 502, the notification unit 312 closes the import result confirmation screen 501.

The roll-back unit 313 executes roll-back processing to return the settings necessary for user authentication processing to the state before performing import processing, after the import unit 302 has started import processing to the image forming device 101. To this end, the roll-back unit 313 executes back-up processing to back up the state before performing import processing upon starting import processing, and utilizes this processing for the roll-back processing.

The back-up processing may be simple file-copying, and may execute export processing to export the export data including the settings necessary for user authentication processing before performing import processing by the export unit 321 described below. Along with this, roll-back, processing may be simple file-copying, and may be import processing of the above exported export data by the import unit 302.

The export instruction accepting unit 320 accepts an instruction to export the setting value of the image forming device 101 using various interfaces provided in the image forming device 101. The export data generated in accordance with the instruction is delivered according to the interface which accepts the instruction. The export unit 321 generates export data in response to the export request accepted by the export instruction accepting unit 320. Further, although the export unit 321 temporarily preserves the export data in the image forming device 101, the preservation area may be the auxiliary storage device 204 or the volatile memory 203.

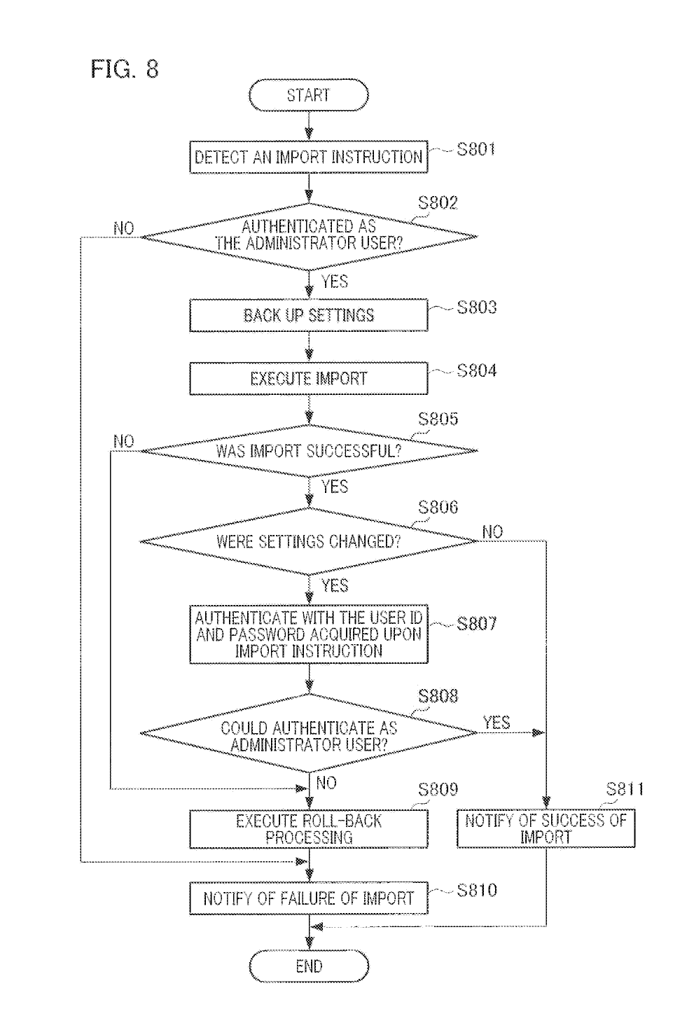

FIG. 8 is a flow chart explaining the operation processing of the image forming device of the first embodiment. First, the import instruction accepting unit 301 accepts an import instruction (S801). Subsequently, the user authentication unit 303 determines whether or not the user who has performed the import instruction is the administrator user (S802). The processing proceeds to S801 when the user who has per for rued the import instruction is not the administrator user. The processing proceeds to S803 when the user who has performed the import instruction is the administrator user. Further, the order of the processing of S802 and the processing of S801 may be reversed. When the processing of S801 is executed ahead, it is presupposed that the import execution instruction screen 401 is displayed only for the administrator user.

In S803, the roll-back unit 313 backs up the settings before import. The information backed up here may be all of the setting information that might be changed in the import processing in the image forming device, or some of the setting information at least including the settings for user authentication processing. Subsequently, the import unit 302 executes import processing of import data in accordance with the contents of the import instruction accepted in S801 (S804).

Next, the import unit 302 determines whether or not import processing has been successful (S805). The processing proceeds to S809 when the import processing has failed. The processing proceeds to S806 when the import processing has been successful, that is, ended normally.

In S806, the setting change detecting unit 310 determines whether or not the settings for user authentication processing have been changed by the execution of import processing in S804. The notification unit 312 issues notification about the success of the import when the settings for user authentication processing have not been changed (S811). The processing proceeds to S807 when the settings for user authentication processing have been changed.

In S807, the confirmation unit 311 executes user authentication using a user ID and password from which the administrator user is authenticable, included in the import instruction accepted in S801. That is, the confirmation unit 311 determines whether or not there are settings that match the user ID and password included in the import instruction in the settings included in the user database after import processing. User authentication is successful when there are settings that match the user ID and password included in the import instruction in the settings included in the user database after import processing. User authentication fails when there are no settings that match the user ID and password included in the import instruction in the settings included in the user database after import processing.

Next, the confirmation unit 311 determines whether or not the user authentication in S807 has been successful as the administrator user in consequence of the authentication (S808). The processing proceeds to S811 when the authentication has been successful as the administrator user. The processing proceeds to S809 when the authentication has failed as the administrator user.

Next, the roll-back unit 313 executes roll-back processing (S809). Specifically, the roll-back unit 313 reflects again the backed-up setting information in S803 in each of the databases such as a user database that manages various settings. Then, the notification unit 312 provides notifies about the failure of import (S810).

In this embodiment, the following processing is performed when the distributed import data is reflected, the authentication information of the user who instructs distribution of import data is input, and the login by authentication processing using the input authentication information in the image forming device fails (No in S808). The image forming device 101 rolls the settings for user authentication processing back to the settings before reflecting import data.

According to this embodiment, when the settings for user authentication processing have been changed due to import processing by the image forming device, and the administrator user cannot be authenticated, this setting can be returned to the state before import processing. Therefore, it is possible to prevent a situation in which a user cannot log in after import processing.

### Second Embodiment

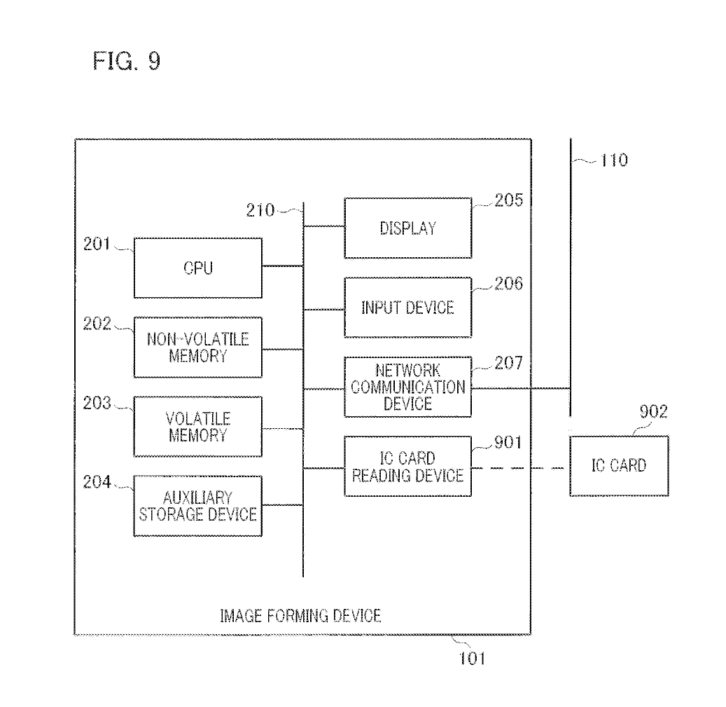

FIG. 3 is an example of the hardware configuration diagram of the image forming device of the second embodiment. Only the differences between FIG. 4 and FIG. 9 will be explained. An IC card reading device 901 is a device for reading the information of an IC card 902 such as Felica and MIFARE. The IC card reading device 901 can read an identifier for uniquely identifying the IC card 902, and a password.

The IC card 902 is an IC card which the IC card reading device 901 can read. An identifier for uniquely identifying the IC card 902, and a password, which can be read with the IC card reading device 901 are stored in the IC card 902.

In the second embodiment, the image forming device 101 considers the identifier stored in the IC card 902 as “uid”, and performs user authentication by reading the information with the IC card reading device 901.

FIG. 10 is a functional block diagram of the system of the second embodiment. The image forming device 101 comprises an import instruction accepting unit 301, an import unit 302, a user authentication unit 303, a setting storage unit 304, a setting change detecting unit 310, a confirmation unit 311, and a notification unit 312. Also, the image forming device 101 comprises a roll-back unit 313, an export instruction accepting unit 320, and an export unit 321. Additionally, the image forming device 101 comprises an IC card user authentication unit 1001, and a standby unit 1002.

The management server comprises an import instruction unit 1011, a result receiving unit 1012, an import result notification unit 1013, and a result distributing unit 1014. The program that achieves the function of each processing unit provided in the image forming device 101 is stored in the non-volatile memory 202 or the auxiliary storage device 204 in the image forming device 101, and executed by the CPU 201. Additionally, various information used upon execution of the program is preserved in the volatile memory 203 or the auxiliary storage device 204 in the image forming device 101. Further, the communication with each information appliance on a network is performed using the network communication device 207 in the image forming device 101.

The program that achieves the function of each processing unit provided in the management server 103 is stored in the non-volatile memory 202 or the auxiliary storage device 204 (not illustrated) provided in the management server 103, and executed by the CPU 201. In addition, various information used upon execution of the program is preserved in a non-volatile memory or the auxiliary storage device 204 in the management server. Further, the communication with each information appliance on a network is performed using a network communication device (not illustrated) in the management server 103.

Explanation is made only about the difference between FIG. 9 and FIG. 5, regarding the processing units which the image forming device 101 comprises. The IC card user authentication unit 1001 reads an identifier and password stored in the IC card 902 with the IC card reading device 901. The IC card user authentication unit 1001 considers the identifier as “uid”, and decides whether or not the information of a user to whose “uid” corresponds is registered in the user database (FIG. 2). When the information of a user to whose “uid” corresponds is registered, the IC card user authentication unit 1001 further decides whether or not the result of hashing the password corresponds to “pwd_hash”.

When the result of hashing the password corresponds to “pwd_hash”, the IC card user authentication unit 1001 considers that the user identified with the “uid” is correctly authenticated, and determines that the user is the administrator user when “admin” is TRUE. When the information of a user to whom “uid” corresponds is not registered in the user database, or the result of hashing the password does not correspond to “pwd_hash”, the IC card user authentication unit 1001 decides that the user identified with the “uid” is not a correct user.

The standby unit 1002 displays a post-import authentication screen, and waits for the user authentication by the administrator user with the IC card 902 when the settings for user authentication processing have been changed due to the import processing by the import unit 302. The post-import authentication screen is a screen that waits for user authentication by the administrator with the IC card 902 when the settings for user authentication processing have been imported by the import unit 302.

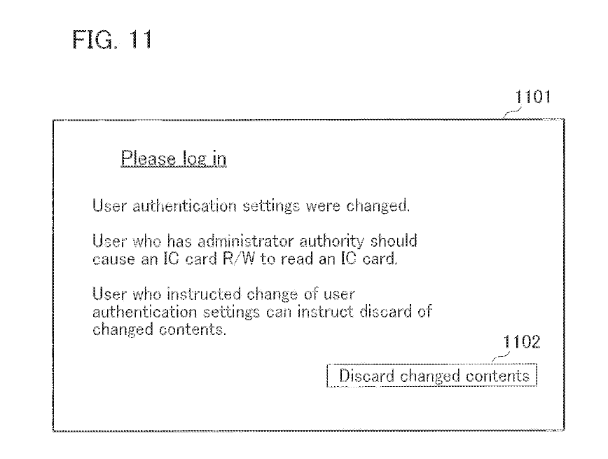

FIG. 11 is a diagram showing an example of a post-import authentication screen. The wording that prompts the administrator user to perform user authentication is displayed on a post-import authentication screen 1101. In the example of FIG. 11, the wording that prompts a user so that the IC card 902 is read by the IC card reading device 901 is displayed.

A discard button 1102 is a button that discards the contents of import processing, and instructs to return the processing to the state before executing import processing. When the administrator user presses down the discard button 1102, the roll-back unit 313 returns various setting information to the state before executing import processing.

The standby unit 1003 displays the post-import authentication screen 1101 and waits until any one of the following conditions is met. The first condition is that the user authentication by the administrator user is successful. The second condition is that the discard button 1102 is pressed down. When the discard button 1102 is pressed down, the roll-back unit 313 returns the settings for user authentication processing to the state before executing import processing.

The third condition is that the management server 103 issues notification about an import result. When notified by the management server 103 that the import has been successful in another image forming device 101, the standby unit 1002 determines that the post-import authentication is successful. When notified from the management server 103 that the import has failed in another image forming device 101, the roll-back unit 313 returns various setting information to the state before executing import processing.

The fourth condition is that the predetermined time elapses. When the user authentication by the administrator user is not successful even after the predetermined time has elapsed, the roll-back unit 313 returns various setting information to the state before executing import processing. Any one of the above four conditions may be applied, or a plurality of conditions may be applied in combination.

Next, the processing units provided in the management server 103 are explained. The import instruction unit 1011 performs an import instruction to the import instruction accepting unit 301 is provided in the image forming device 101. The import instruction unit 1011 transmits the information of the import instruction that the import instruction accepting unit 301 requires to the import instruction accepting unit 301 via the LAN 110. Import data is included in the information of the import instruction. In addition, the import instruction unit 1011 can simultaneously issue instructions about the import instructions with the same contents to a plurality of image forming devices 101 which are communicable by way of the LAN 110.

The result receiving unit 1012 receives an import result sent from the notification unit 312 of the image forming device 101. The import result may be either successful or unsuccessful. The import result notification unit 1013 notifies the user who performs the import instruction of the import result received by the result receiving unit 1012.

The result distributing unit 1014 notifies another image forming device 101 that has performed the import instruction from the import instruction unit 1011 of the import result received by the result receiving unit 1012. The result distributing unit 1014 performs notification only once about one import instruction.

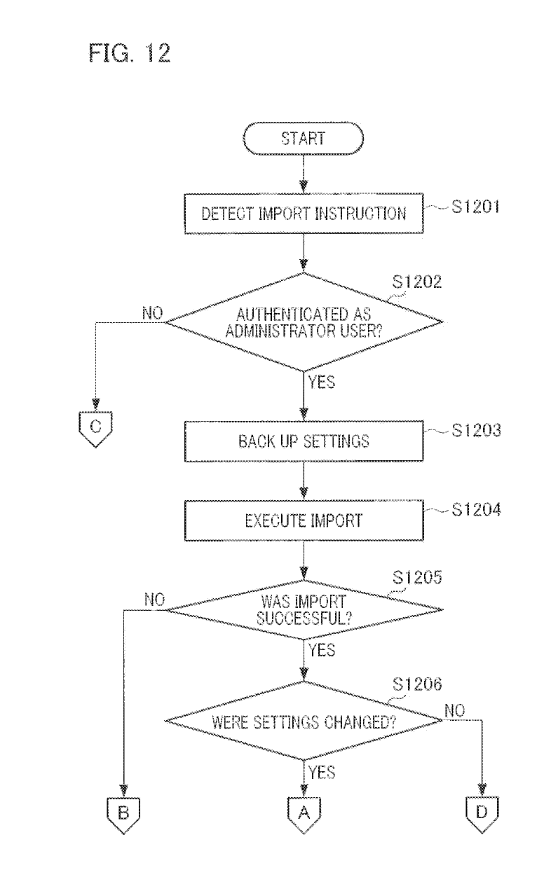

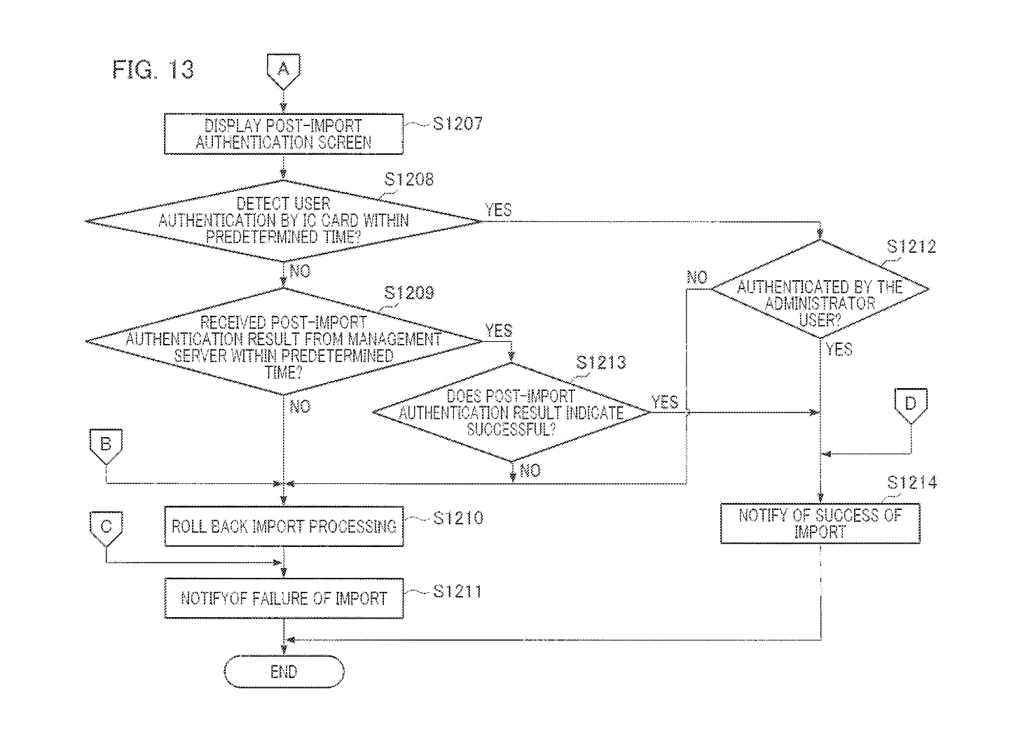

FIG. 12 and FIG. 13 are flow charts explaining the operation processing of the image forming device of the second embodiment. S1202 through S1206 in FIG. 12 are similar to S801 through S806 in FIG. 8.

In S1207 of FIG. 13, the standby unit 1002 displays a post-import authentication screen. That is, in the image forming device 101, the processing enters a login standby state when the distributed import data has been reflected, and the input of authentication information is queued. Subsequently, the standby unit 1002 determines whether or not the user authentication by the IC card 902 within a predetermined time has been detected (S1208). Processing proceeds to S1212 when the standby unit 1002 has detected the user authentication by the IC card 902 within a predetermined time. Processing proceeds to S1209 when the standby unit 1002 has not detected the user authentication by the IC card 902 within a predetermined time.

In S1209, the standby unit 1002 determines whether or not it has received a post-import authentication result in another image forming device from the management server 103 within a predetermined time. Processing proceeds to S1213 when the standby unit 1002 has received a post-import authentication result from the management server 103 within a predetermined time. Processing proceeds to S1210 when the standby unit 1002 has not received a post-import authentication result from the management server 103 within a predetermined time.

In S1210, the roll-back unit 313 reflects again the setting information backed up in S1203 by executing roll-back processing in a corresponding database. Then, the notification unit 312 issues notifications that the import result indicates failure (S1211).

In S1212, the IC card user authentication unit 1001 determines whether or not the authentication of the administrator user has been successful. The notification unit 312 issues notifications that the import result indicates successful when the authentication of the administrator user has been successful (S1214). Processing proceeds to S1210 when the authentication of the administrator user has not been successful.

In S1213, the standby unit 1002 determines whether the post-import authentication result received in S1209 indicates successful or not. Processing proceeds to S1214 when the post-import authentication result indicates successful. Processing proceeds to S1210 when the post-import authentication result indicates failure. That is, the standby unit 1002 determines whether roll-back processing is executed, or the success of import is notified based on the success or failure of the test login in another image forming device in which import data has been reflected to thereby switch the processing. Therefore, it means that the import result notification unit 1013 provided in the management server 103 causes one or more another image forming devices, to which the same import data as the above import data has been distributed, to synchronize the success or failure of the test login in the image forming device in which import data has been reflected.

Based on the explanation with reference to FIG. 12 and FIG. 13, in this embodiment, the authentication information of the user who issues instructions about the distribution of import data is input by performing card authentication in the image forming device 101 (S1208). Then, when the test login using the input authentication information has failed (No in S1212), the image forming device 101 rolls back the import data to the settings before the import data is reflected (S1210). Additionally, in this embodiment, when a certain time elapses since a test login wait state has started, or the discard of the settings change as a result of the reflection of import data is designated, the image forming device executes roll-back processing.

The operation processing of the management server 103 in the second embodiment is as follows. The management server 103 issues instructions about the execution of import processing to the image forming device 101 via the import instruction unit 1011. Then, the image forming device 101 enters the standby state until import processing is finished. Upon receipt of an import result from the image forming device 101, the result receiving unit 1012 notifies a user of the management server 103 of the import result via the notification unit 312. At the same time, the result distributing unit 1014 distributes the post-import authentication result to the remaining image forming devices 101 to which the instruction has been made via the import instruction unit 1011.

As shown in this embodiment, by providing the process in which the standby unit 1002 determines whether or not a user can be authenticated as an administrator user, it is possible to prevent a situation in which the administrator user cannot perform user authentication after import. Furthermore, upon import in a plurality of image forming devices 101 by the management server 103, the labor of doing user authentication in all image forming devices 101 can be prevented.

As a variant example of this embodiment, the import instruction unit 1011 of the management server 103 may function as an input unit for inputting authentication information of a user who has issued instruction for the distribution of import data in accordance with the designation of the import data. Specifically, the import instruction unit 1011 sends the user ID and password of the administrator user who instructed the import together with the import data to the import instruction accepting unit 301 of the image forming device 101. After import processing, the standby unit 1002 determines whether or not the user can be authenticated as the administrator user based on the user ID and password of the administrator user sent from the above import instruction unit 1011. Then, when the user cannot be authenticated as the administrator user, the roll-back unit 313 executes roll-back processing.

### Third Embodiment

The roll-back unit 313 may execute roll-back processing with detailed consideration of the associations or the settings for user authentication processing. Although a user database is recited as a specific example of the settings for user authentication processing, it is assumed that double user authentication is performed by combining two kinds of user databases, and that there is association with another setting. In this case, the roll-back unit 313 rolls back all the associated settings for user authentication processing. The association of settings is managed in a table or in a database (not illustrated), the roll-back unit 313 performs roll-back processing with reference to this association of settings.

In addition, the image forming device 101 may adopt a configuration capable of replacing the user authentication unit 303. In the case of adopting this configuration, the image forming device 101 manages information regarding an access authority to a user database and of the replaceable user authentication unit. Then, when the authentication of the administrator user has failed after import processing, the roll-back unit 313 performs roll-back processing on the setting within a range in which the replaceable user authentication unit is accessible, based on the information regarding the managed access authority.

Additionally, the replaceable user authentication unit 303 may preserve a definition file (not illustrated) representative of the association of the settings for user authentication processing. In the case of adopting this configuration, the roll-back unit 313 performs roll-back processing in accordance with the definition file (not illustrated).

The roll-back unit 313 may back up the settings for user authentication processing, for example, only when the settings for user authentication processing are included in the import instruction. Additionally, in the above-described first and second embodiments, although the auxiliary storage device 204 stores the settings for user authentication processing of the image forming device 101, another storage medium, for example, the non-volatile memory 202 may store the settings. Additionally, the settings may be stored in a location in which the image forming device 101 is capable of referencing on a network.

In addition, in the first and second embodiments, although the import instruction accepting unit 301 is capable of accepting the import instruction from four routes, for example, the import instruction accepting unit 301 may accept only the import instruction from one route. Alternatively, the import instruction accepting unit 301 may be capable of accepting the import instruction from more than four routes.

The import instruction accepted by the import instruction accepting unit 301 may be divided into a plurality of sections. Additionally, the import instruction accepting unit 301 may accept the import instruction along with the information ether than the import instruction.

In addition, the notification unit 312 may notify of an import result in a method other than the notification methods in the first and second embodiments. For example, the notification unit 312 may place an import result file on the shared folder. Additionally, the notification unit 312 may notify a specific server of an import result in an HTTP communication.

In The second embodiment, the discard button 1102 of the post-import authentication screen 1101 could be pressed down, with or without user authentication. However, a configuration in which someone other than the administrator can nullify the import instruction by the administrator user may be undesirable. Thereupon, a configuration may be applied in which a one-time password is instructed in addition to the import instruction. That is, the import instruction accepting unit 301 accepts a one-time password together with the import instruction.

In addition, the standby unit 1002 displays a password input screen (not illustrated) upon a press of the discard button 1102. Furthermore, the standby unit 1002 determines whether or not the password input on the password input screen (not illustrated) coincides with the one-time password accepted together with the import instruction. When the password coincides with the one-time password, the standby unit 1002 permits discard of the import instruction. When the password does not coincide with the one-time password, the standby unit 1002 does not permit discard of the import instruction. By the above configuration, a case can be prevented in which someone other than the user who performed the import instruction issues instructions about the roll-back of import processing without permission. Although a one-time password is used as-is in the above-described configuration, it may be a configuration in which checking is performed using hashed data. In addition, rather than a one-time password, the user ID and password of the user who instructed import processing may be used.

Although explanation has been made reciting a user database as an example of the settings for user authentication processing, it may be another configuration. For example, the settings for user authentication processing may be other settings to switch software that performs user authentication. In this case, the import of the settings to switch software that performs user authentication is performed by the import unit 302, and the software that performs user authentication is changed. The settings to switch software that performs user authentication are returned back by the roll-back unit 313, and the software that performs user authentication is changed. Thus, each configuration achieved in the first embodiment or the second embodiment can also adopt another configuration, which enables obtaining the equivalent effects or additional effects explained in each paragraph.

Aspects or the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims benefit from Japanese Patent Application No. 2011-159900 filed on Jul. 18, 2012, which is hereby incorporated by reference herein in its entirety.

What is claimed is:

1. A distribution device that distributes import data including a plurality of setting values to an image forming device, comprising:
a designation unit configured to designate an image forming device to which the import data is distributed; and
a distribution unit configured to distribute the import data to the designated image forming device,
wherein, when the distributed import data is reflected in the image forming device, the authentication information of a user who instructs the distribution of the import data is input, and a login by the authentication processing using the input authentication information fails, the image forming device rolls the settings back to the settings before the import data is reflected.

2. The distribution device according to claim 1, further comprising an input unit configured to input the authentication information of the user who instructs the distribution of the import data in accordance with the designation of the import data to be distributed,
wherein the distribution unit distributes the input authentication information along with the import data to the designated image forming device.

3. The distribution device according to claim 1, wherein, when the distributed import data is reflected, the image forming device enters into a test login standby state, and waits for the input of the authentication information.

4. The distribution device according to claim 3, wherein, when the authentication information of the user who instructs the distribution of the import data is input by card authentication in the image forming device, and the test login using the input authentication information fails, the image forming device rolls the settings back to the settings before the import data is reflected.

5. The distribution device according to claim 3, wherein when a predetermined time elapses after the image forming device enters into the test login standby state, or when the discard of a settings change due to the reflection of the import data is designated, the image forming device rolls the settings back to the settings before the import data is reflected.

6. The distribution device according to claim 3, further comprising a synchronization unit configured to cause one or more another image forming devices, to which the same import data as the import data is distributed by the distribution unit, to synchronize the success or failure of the test login in the image forming device in which the import data is reflected.

7. A method for controlling a distribution device that distributes import data including a plurality of setting values to an image forming device, the method comprising:
designating an image forming device to which the import data is distributed; and
distributing the import data to the designated image forming device,
wherein when the distributed import data is reflected in the image forming device, the authentication information of the user who instructs the distribution of the import data is input, and a login by the authentication processing using the input authentication information fails, the image forming device rolls the settings back to the settings before the import data is reflected.

8. A non-transitory storage medium on which is stored a computer program for making a computer execute a method for controlling a distribution device that distributes import data including a plurality of setting values to an image forming device, the method comprising:
designating an image forming device to which the import data is distributed; and
distributing the import data to the designated image forming device,
wherein when the distributed import data is reflected in the image forming device, the authentication information of the user who instructs the distribution of the import data is input, and a login by the authentication processing using the input authentication information is unsuccessful, the image forming device rolls the settings back to the settings before the import data is reflected.

9. An image forming device comprising:
a reception unit configured to receive import data including a plurality of setting values from a distribution device;
a reflection unit configured to reflect the received import data in an own device;
an acceptance unit configured to accept an input of authentication information by a user who has instructed the distribution of the import data;
a determination unit configured to determine the success or failure of a login to the own device by performing authentication processing using the input authentication information; and
a roll-back unit configured to roll the settings back to the settings before the import data is reflected when the login fails.

10. The image forming device according to claim 9, wherein the image forming device enters into a test login standby state upon reflection of the import data by the reflecting unit, and
Wherein, when a predetermined time elapses after the test login standby state, or when the discard of a settings change due to the reflection of the import data is designated, the roll-back unit rolls the settings back to the settings before the import data is reflected.

11. The image forming device according to claim 9, wherein the accepting unit accepts the input of authentication information by a card authentication by the user.

12. The image forming device according to claim 9, further comprising a notification unit configured to notify the distribution device of the success of the login based on the determination by the determining unit for synchronization of the settings with one or more another image forming devices to which the same import data as the import data has been distributed.

13. A method for controlling an image forming device, the method comprising:
receiving import data including a plurality of setting values from a distribution device;
reflecting the received import data in an own device;
accepting the input of the authentication information of the user who has instructed a distribution of the import data;
performing authentication processing using the input authentication information and determining the success or failure of a login to the own device by; and
rolling the settings back to the settings before the import data is reflected when the login fails.

14. A non-transitory storage medium on which is stored a computer program for making a computer execute a method for controlling an image forming device, the method comprising:
receiving import data including a plurality of setting values from a distribution device;
reflecting the received import data in an own device;
accepting the input of the authentication information of the user who has instructed the distribution of the import data;
performing authentication processing using the input authentication information and determining the success or failure of a login to the own device by; and
rolling the settings back to the settings before the import data is reflected when the login fails.

15. A system comprising an image forming device, and a distribution device that distributes import data including a plurality of setting values to the image forming device,
wherein the distribution device comprises:
a designation unit configured to designate an image forming device to which the import data is distributed; and
a distribution unit configured to distribute the import data to the designated image forming device, and
wherein the image forming device comprises:
a reception unit configured to receive the import data distributed from the distribution device;
a reflection unit configured to reflect the received import data in the image forming device;
an acceptance unit configured to accept an input of authentication information of a user who has instructed the distribution of the import data;
a determination unit configured to determine the success or failure of a login to the image forming device by performing authentication processing using the input authentication information; and
a roll-back unit configured to roll the settings back to the settings before the import data is reflected when the login fails.
